(19) United States
(12) Patent Application Publication
(10) Pub. No.: US 2023/0409293 A1
(43) Pub. Date: Dec. 21, 2023

(54) SYSTEM AND METHOD FOR DEVELOPING AN ARTIFICIAL SPECIFIC INTELLIGENCE (ASI) INTERFACE FOR A SPECIFIC SOFTWARE

(71) Applicant: Lucinetic Inc, Pasadena, CA (US)

(72) Inventors: Konstantin Y. Batygin, Pasadena, CA (US); Gregory P. Laughlin, Hamden, CT (US)

(21) Appl. No.: 18/337,770

(22) Filed: Jun. 20, 2023

Related U.S. Application Data
(60) Provisional application No. 63/353,661, filed on Jun. 20, 2022.

(51) Int. Cl. G06F 8/34; G06N 20/00; G06F 40/166; G06F 40/226

(52) U.S. Cl. CPC G06F 8/34; G06N 20/00; G06F 40/166; G06F 40/226

(57) ABSTRACT

A system and method for developing an artificial specific intelligence (ASI) interface for specific software. The system identifies a specific software package and the user base. The system creates an interaction model for the software based on how users interact with it. Using this model, an initial version of the ASI interface is generated. The system deploys this initial version to a subset of the user base and collects interaction data between the ASI interface and the users. By analyzing the interaction data, the system identifies interaction patterns and pre-defined issues faced by the users. A machine learning model is trained using these patterns and issues. Finally, the system optimizes the initial ASI interface based on the trained machine-learning model.

### CROSS-REFERENCE TO RELATED APPLICATION(S)

This application claims the priority to incorporate by reference the entire disclosure of U.S. provisional patent application No. 63/353,661, filed on Jun. 20, 2022, titled “System and method for segment-by-segment modular long-form text generation using natural language processing (NLP)”.

### FIELD OF DISCLOSURE

Embodiments of the present disclosure generally relate to artificial intelligence (AI) systems and more particularly relate to a system and a method for developing an artificial specific intelligence (ASI) interface for a specific software to create a tailored AI interface for specific software or workflow systems. The present disclosure enables specialized AI agents to fully understand and interact with software or workflow systems intuitively and naturally, guiding users through tasks, answering questions, automating complex sequences of actions, and learning to anticipate user needs.

### BACKGROUND

Generally, the software applications and workflow systems may also need to understand mental, physical, social, and emotional problems occurring when an individual spends long period for a long time to write or read long documents or type or read on a computer. The individual may have social issues such as unethical or discriminatory language, frustration related to fatigue, errors, writer's block, and the like. Accurate evaluation of candidates for academic positions, as well as business communications in general, stands on the extraction of de-biased information from large corporations of letters of recommendation. For many employment opportunities in academia and industry, including short-term engagements such as summer research internships, and the like, the number of applicants applying to a given position may exceed one hundred. Every candidate generally arranges for three recommenders to submit letters of recommendation on their behalf to the organizations. Text of these letters of recommendation, moreover, contain subtle gradations of nuance that need to be correctly parsed to generate final candidate rank orderings.

Conventionally, the systems do not create structured long-form text that is specific and variable-driven documents to the user. The conventional systems may not create fully self-consistent variable-driven documents with a beginning, middle, and end section. However, conventional systems do not guide users through tasks, answer their questions, automate complex sequences of actions, and adaptively learn to anticipate their needs. Further, conventional systems may not bridge the gap between user intent and the complexity of software or workflow systems. Additionally, conventional systems may not interact with users in a manner that is intuitive, natural, and aligned with the user's intentions, allowing the user to obtain high-quality outcomes.

Additionally, using the software applications and workflow systems, users often face challenges in efficiently utilizing these tools to achieve their desired outcomes. A plurality of software packages offers extensive functionality; however, users may lack the domain expertise or time required to utilize these features effectively. Similarly, workflow systems may involve intricate procedures or interactions that users must follow to achieve desired outcomes, however, the workflow systems may lack the expertise or time to execute them proficiently.

Therefore, there is a need for an improved system and a method for developing an artificial specific intelligence (ASI) interface for specific software to create a tailored AI interface for specific software or workflow systems and for segment-by-segment modular long-form text generation, which fully understand and interact with software or workflow systems intuitively and naturally, guiding users through tasks, answering questions, automating complex sequences of actions, and learning to anticipate user needs, to address at least the aforementioned issues in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a computing system for developing an artificial specific intelligence (ASI) interface for specific software. The system identifies a specific software package and a user base for generating an artificial specific intelligence (ASI) interface. Further, the system generates an interaction model for the identified specific software package based on a medium of interaction with a user. Furthermore, the system generates an initial version of the ASI interface comprising the generated interaction model. Additionally, the system deploys the generated initial version of the ASI interface with a subset of the user base. Further, the system periodically obtains interaction data between the ASI interface and the user. Furthermore, the system identifies interaction patterns and pre-defined issues associated with the user by analyzing the obtained interaction data. Additionally, the system trains a machine-learning model based on the identified interaction patterns and the pre-defined issues associated with the user. Also, the system optimizes the initial version of the ASI interface based on the trained machine-learning model.

Another aspect of the present disclosure provides a computer-implemented method for developing an artificial specific intelligence (ASI) interface for specific software. The method includes identifying a specific software package and a user base for generating an artificial specific intelligence (ASI) interface. Further, the method includes generating an interaction model for the identified specific software package based on a medium of interaction with a user. Furthermore, the method includes generating an initial version of the ASI interface comprising the generated interaction model. Additionally, the method includes deploying the generated initial version of the ASI interface with a subset of the user base. Further, the method includes periodically obtaining interaction data between the ASI interface and the user. Additionally, the method includes identifying interaction patterns and pre-defined issues associated with the user by analyzing the obtained interaction data. Furthermore, the method includes training a machine learning model based on the identified interaction patterns and the pre-defined issues associated with the user. Further, the method includes optimizing the initial version of the ASI interface based on the trained machine-learning model.

Yet another aspect of the present disclosure provides a non-transitory computer-readable storage medium having programmable instructions stored therein. When executed by one or more hardware processors, cause the one or more hardware processors to identify a specific software package and a user base for generating an artificial specific intelligence (ASI) interface. Further, the one or more hardware processors generate an interaction model for the identified specific software package based on a medium of interaction with a user. Furthermore, the one or more hardware processors generate an initial version of ASI interface comprising the generated interaction model. Additionally, the one or more hardware processors deploy the generated initial version of the ASI interface with a subset of the user base. Furthermore, the one or more hardware processors periodically obtain interaction data between the ASI interface and the user. Further, the one or more hardware processors identify interaction patterns and pre-defined issues associated with the user by analyzing the obtained interaction data. Additionally, the one or more hardware processors train a machine-learning model based on the identified interaction patterns and the pre-defined issues associated with the user. Furthermore, the one or more hardware processors optimize the initial version of the ASI interface based on the trained machine-learning model.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a system for developing an artificial specific intelligence (ASI) interface for a specific software, in accordance with an embodiment of the present disclosure;

FIG. 2 illustrates an exemplary block diagram representation of a computer-implemented system, such as those shown in FIG. 1, capable of developing an artificial specific intelligence (ASI) interface for specific software, in accordance with an embodiment of the present disclosure;

FIG. 3 illustrates an exemplary block diagram representation of a scenario of segment-by-segment modular long-form text generation, in accordance with an embodiment of the present disclosure;

FIG. 4 illustrates a flow chart depicting a method of developing an artificial specific intelligence (ASI) interface for specific software, in accordance with the embodiment of the present disclosure; and

FIG. 5 illustrates an exemplary block diagram representation of a hardware platform for an implementation of the disclosed system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for developing an artificial specific intelligence (ASI) interface for specific software. The present disclosure distinguishes between two modes of interaction enabled by the ASI interface. In the first mode, the ASI interface replaces human input to interact with complex third-party software packages. The ASI interface utilizes application programming interfaces (APIs) provided by the software to perform tasks and functions, eliminating the need for users to have extensive knowledge of the software's intricacies. The AI interface serves as an intermediary between the user and the software, streamlining the user experience and enhancing productivity. In the second mode, the ASI interface assists users in following pre-existing workflow systems. These systems consist of stylized procedures or interactions necessary to achieve specific outcomes, such as generating a letter of recommendation/reference for a technical job position. Further, the AI interface understands the workflow system's requirements and guides users through the process, ensuring that all steps are executed correctly and efficiently. By providing contextual assistance and automating repetitive tasks, the AI interface empowers users to obtain the desired outcome without requiring deep domain expertise.

The present disclosure provides a tailored AI interface that bridges the gap between user intent and the complexity of software or workflow systems. By leveraging the capabilities of the ASI interface, the AI interface enhances user productivity, provides intuitive and natural interactions, automates complex sequences of actions, and adapts to user needs, such as interacting with the users in a manner that is intuitive, natural, and aligned with the user's intentions, allowing the users to obtain high-quality outcomes.

For example, the ASI interface facilitates the navigation of complex software by guiding users step-by-step, especially in systems with intricate learning curves or vast parameter combinations. Through interactions, the ASI assesses and dynamically adapts to user skill levels, providing appropriate guidance for beginners and efficient instructions for experts. Further, the ASI interface, with its deep understanding of the software, the ASI can automate intricate sequences of actions by leveraging APIs and running test assessments. For instance, in graphics design software, the ASI can optimize filters and adjustments automatically based on user instructions. Overtime, the ASI interface learns from user behavior to deliver personalized assistance. It identifies frequently performed tasks, making them more accessible, and tailors interface layouts and notification settings according to user preferences. This capability is particularly valuable for office productivity software, eliminating unnecessary features for specific user tasks. Furthermore, the ASI interface enhances software accessibility for individuals with disabilities. The ASI interface can interpret voice commands for those with difficulties using traditional input methods like a mouse or keyboard. Additionally, it can provide descriptions of visual elements for users with vision impairments.

Further, the present disclosure enables users to achieve their desired outcomes by utilizing a tailored AI interface for specific software or workflow systems. The artificial specific intelligence (ASI) interface may possess a deep understanding of the functionalities and capabilities of the target software or workflow system. It leverages this knowledge to guide users through tasks, answer user questions, automate complex sequences of actions, and adaptively learn to anticipate their needs.

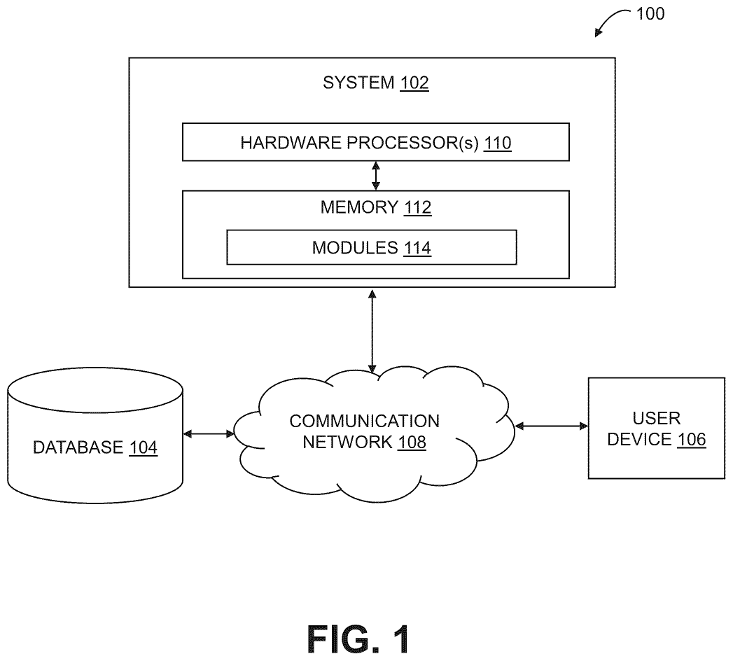

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 implementing a system 102 for developing an artificial specific intelligence (ASI) interface for a specific software, in accordance with an embodiment of the present disclosure. According to FIG. 1, the network architecture 100 may include the system 102, a database 104, and a user device 106. The system 102 may be communicatively coupled to the database 104, and the user device 106 via a communication network 108. The communication network 108 may be a wired communication network and/or a wireless communication network. The database 104 may include, but is not limited to, interaction data, unstructured text data, desired text data, artificial specific intelligence (ASI) interface data, any other data, and combinations thereof. The database 104 may be any kind of database such as, but are not limited to, relational databases, dedicated databases, dynamic databases, monetized databases, scalable databases, cloud databases, distributed databases, any other databases, and combination thereof.

Further, the user device 106 may be associated with, but not limited to, a user, an individual, an administrator, a vendor, a technician, a worker, a specialist, an instructor, a Specific visor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. The user device 106 may be used to provide input and/or receive output to/from the system 102, and/or to the database 104, respectively. The user device 106 may present to the user one or more user interfaces for the user to interact with the system 102 and/or to the database 104 for developing an artificial specific intelligence (ASI) interface for specific software needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for developing an artificial specific intelligence (ASI) interface for specific software. Execution of the machine-readable program instructions by the hardware processor 110 may enable the proposed system 102 to develop an artificial specific intelligence (ASI) interface for specific software. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at different locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may identify a specific software package and a user base for generating an artificial specific intelligence (ASI) interface (not shown in FIG. 1). The specific software package may include complex third-party packages with accessible applications programming interfaces (APIs) for replacing human input. For example, one or more workflow systems involve stylized procedures or interactions to achieve desired outcomes, such as producing a letter of recommendation/reference.

In an exemplary embodiment, the system 102 may be further configured to pre-process the unstructured text data obtained from letters of reference extracted from the user base. Further, the the system 102 may be configured to generate machine-learning-based summaries of the pre-processed unstructured text data using an AI-based summarization algorithm. Furthermore, the the system 102 may be configured to validate the generated machine-learning-based summaries based on one or more predefined rules. Further, the the system 102 may be configured to map text with the model variables to generate long-form structured text data desired by the user.

In an exemplary embodiment, to pre-process the unstructured text data obtained from letters of reference extracted from the user base, the the system 102 may be further configured to parse letters comprised in the unstructured text data using a decision tree-based model to filter segments lacking actionable intent. Further, the the system 102 may be configured to filter unstructured text data to remove gendered language. Furthermore, the the system 102 may be configured to tune stereotyped phrases to generate a neutral tone in the unstructured text data.

In an exemplary embodiment, the system 102 may generate an interaction model for the identified specific software package based on a medium of interaction with a user. In an exemplary embodiment, the system 102 may generate an initial version of the ASI interface comprising the generated interaction model. In an exemplary embodiment, the system 102 may deploy the generated initial version of the ASI interface with a subset of the user base. In an exemplary embodiment, the system 102 may periodically obtain interaction data between the ASI interface and the user.

In an exemplary embodiment, the system 102 may identify interaction patterns and pre-defined issues associated with the user by analyzing the obtained interaction data. In an exemplary embodiment, the system 102 may train a machine learning model based on the identified interaction patterns and the pre-defined issues associated with the user. In an exemplary embodiment, the system 102 may optimize the initial version of the ASI interface based on the trained machine learning model. In an exemplary embodiment, the system 102 may generate one or more machine learning-based insights for the identified interaction patterns and pre-defined issues associated with the user.

For example, the system 102 utilizes generative pre-trained transformer (GPT) type modules or any other language transformer model to generate and co-write text that may be assembled into a coherent, dependent, and intelligent document. The present disclosure comprises a methodology of mapping text and variables and stitching together artificial intelligence (AI) generated text to create self-consistent long-form text. The system 102 may be a software framework. The methodology of mapping the text and the variables is performed in the following manner: firstly, a set of variables pertinent to the specific class of documents is created. Subsequently, the use of said variables is mapped out throughout individual segments of a said document. Thirdly, creating a training set is created which may be utilized to train specific language models to generate individual segments of the documents with varied degrees of specificity and complexity. Fourthly, a required sequence of fine-tuned language models is trained to generate the text.

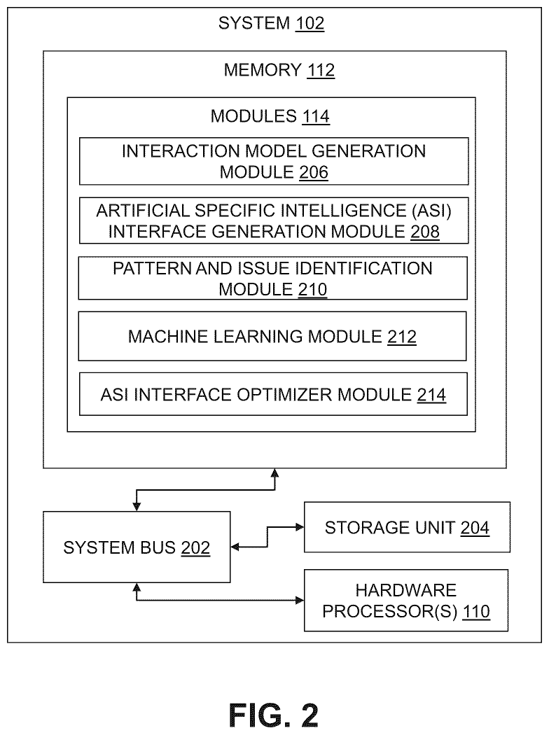

FIG. 2 illustrates an exemplary block diagram representation of a computer-implemented system, such as those shown in FIG. 1, capable of developing an artificial specific intelligence (ASI) interface for a specific software, in accordance with an embodiment of the present disclosure. The system 102 may also function as a computer-implemented system (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes an interaction model generation module 206, an artificial specific intelligence (ASI) interface generation module 208, a pattern and issue identification module 210, a machine learning module 212, and an ASI interface optimizer module 214.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database such as those shown in FIG. 1. The storage unit 204 may store, but is not limited to, unstructured text data, desired text data, artificial specific intelligence (ASI) interface data, any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the interaction model generation module 206 may be configured to identify a specific software package and a user base for generating an artificial specific intelligence (ASI) interface. Further, the interaction model generation module 206 may be configured to generate an interaction model for the identified specific software package based on a medium of interaction with a user.

In an exemplary embodiment, the ASI interface generation module 208 may be configured to generate an initial version of the ASI interface comprising the generated interaction model. Further, the ASI interface generation module 208 may be configured to deploy the generated initial version of the ASI interface with a subset of the user base.

In an exemplary embodiment, the pattern and issue identification module 210 may be configured to periodically obtain interaction data between the ASI interface and the user. Further, the pattern and issue identification module 210 may be configured to identify interaction patterns and pre-defined issues associated with the user by analyzing the obtained interaction data. To identify the interaction patterns and the pre-defined issues, the pattern and issue identification module 210 may be further configured to identify user behavior patterns and user preference patterns on the ASI interface. Further, the pattern and issue identification module 210 may be configured to store the identified user behavior pattern and the user preference pattern in the ASI interface.

In an exemplary embodiment, the machine learning module 212 may be configured to train a machine learning model based on the identified interaction patterns and the pre-defined issues associated with the user. In an exemplary embodiment, to train the machine learning model based on the identified interaction patterns and the pre-defined issues associated with the user, the machine learning module 212 may be further configured to receive unstructured text data as the user base from the user. In an exemplary embodiment, the machine learning module 212 may be configured to classify and select language models for the received unstructured text data based on the user base to generate model variables.

In an exemplary embodiment, the machine learning module 212 may be configured to assign the generated model variables to the identified interaction patterns to generate desired text data. In an exemplary embodiment, the machine learning module 212 may be configured to analyze the interaction patterns of the user with the ASI interface using a pre-trained language generation model to generate the desired text data. In an exemplary embodiment, the machine learning module 212 may be configured to display the desired text data on the ASI interface for reviewing and formatting. In an exemplary embodiment, the machine learning module 212 may be configured to tune and modify the desired text data based on the user preference and the identified pre-defined issues associated with the user. In an exemplary embodiment, the machine learning module 212 may be configured to retrain the machine learning model based on the tuned and modified desired text data.

In an exemplary embodiment, the machine learning module 212 may be further configured to pre-process the unstructured text data obtained from letters of reference extracted from the user base. Further, the machine learning module 212 may be configured to generate machine-learning-based summaries of the pre-processed unstructured text data using an AI-based summarization algorithm. Furthermore, the machine learning module 212 may be configured to validate the generated machine-learning-based summaries based on one or more predefined rules. Further, the machine learning module 212 may be configured to map text with the model variables to generate long-form structured text data desired by the user.

In an exemplary embodiment, to pre-process the unstructured text data obtained from letters of reference extracted from the user base, the machine learning module 212 may be further configured to parse letters comprised in the unstructured text data using a decision tree-based model to filter segments lacking actionable intent. Further, the machine learning module 212 may be configured to filter unstructured text data to remove gendered language. Furthermore, the machine learning module 212 may be configured to tune stereotyped phrases to generate a neutral tone in the unstructured text data.

In an exemplary embodiment, to generate the machine-learning-based summaries of the pre-processed unstructured text data using the AI-based summarization algorithm, the machine learning module 212 may be further configured to generate the machine-learning-based summaries of the pre-processed unstructured text data using a transformer encoder-encoder machine learning model with a bidirectional encoder and an autoregressive decoder.

In an exemplary embodiment, the ASI interface optimizer module 214 may be configured to optimize the initial version of the ASI interface based on the trained machine learning model. In an exemplary embodiment, the ASI interface optimizer module 214 may be configured to generate one or more machine learning-based insights for the identified interaction patterns and pre-defined issues associated with the user. To optimize the initial version of the ASI interface based on the trained machine learning model, the ASI interface optimizer module 214 may be further configured to learn one or more types of tasks performed by the user on the ASI interface. Further, the ASI interface optimizer module 214 may be configured to generate accessible instances of one or more types of tasks performed by the user. Furthermore, the ASI interface optimizer module 214 may be further configured to provide the generated accessible instances of one or more types of tasks to the user at run-time.

In an exemplary embodiment, to optimize the initial version of the ASI interface based on the trained machine learning model, the ASI interface optimizer module 214 may be further configured to analyze the identified specific software package received as input from the user. Further, the ASI interface optimizer module 214 may be configured to execute one or more test assessments on the specific software package via an application programming interface. Further, the ASI interface optimizer module 214 may be configured to optimize the initial version of the ASI interface based on the results of the one or more test assessments.

In an exemplary embodiment, to optimize the initial version of the ASI interface based on the trained machine learning model, the ASI interface optimizer module 214 may be configured to automate complex sequences of actions required to be performed on the specific software package based on the identified interaction patterns and the pre-defined issues associated with the user.

In an exemplary embodiment, to optimize the initial version of the ASI interface based on the trained machine learning model, the ASI interface optimizer module 214 may be configured to interpret user input commands received from the user with a disability. Further, the ASI interface optimizer module 214 may be configured to generate one or more user-preferred output commands corresponding to the ASI interface based on the interpreted user input commands received from the user with the disability. The one or more user-preferred output commands correspond to a type of disability of the user.

For example, the pattern and issue identification module 210 may regularize text from letters of recommendation which is in the form of .docx or .pdf or similar format which is uploaded through a web portal by an individual. Regularization comprises decision-tree-based scanning of the letters of recommendation to remove segments that lack actionable intent such as letterhead content, salutations, stock greetings, and pro-forma dosing texts. The regularization may further comprise the removal of gendered language. The procedure of the aforementioned task is also based on a decision tree.

The pattern and issue identification module 210 may further produce machine-learning-enabled summaries of the regularized text from the letter of recommendation. A summarization algorithm rests on an open-source artificial intelligence for the generative pre-trained transformer (GPT), generative artificial intelligence (AI) chatbot, or similar framework. The artificial intelligence for the generative pre-trained transformer (GPT), generative artificial intelligence (AI) chatbot, or similar framework consists of a transformer encoder-decoder machine learning model with a bidirectional encoder and an autoregressive decoder. The pattern and issue identification module 210 may utilize a frequently updated fine-tuning of the open-source model framework outputs summaries that are targeted at ⅕th to 1/10^{th} length of a parent letter's text (also referred to as a letter of recommendation). For example, the framework may be a specific example of a summarizer model.

The system 102 may summarize texts to permit evaluators to quickly comprehend top-level information conveyed in the letter of recommendation. Additionally, both original unregularized text and regularized pre-summary digests are also available for display. The evaluator is given an option (however not a requirement) to provide a quality assessment of the summarized text.

The system 102 may run in an offline batch-computing environment with cloud server instances and a corpus of text plus summary pairs that are utilized as input to a computationally intensive fine-tuning cycle for the generative artificial intelligence (AI) chatbot model. As a training set, the rests on board corpus of labeled text, including, news daily, mail corpus, and the like, which consists of a large selection of professionally edited text-summary pairs. The system 102 updates this corpus of text with inputs that have been deemed of high quality by the users or evaluators. The computationally intensive fine-tuning cycle provides the ability to create more specific and targeted text output that is relevant to a use case.

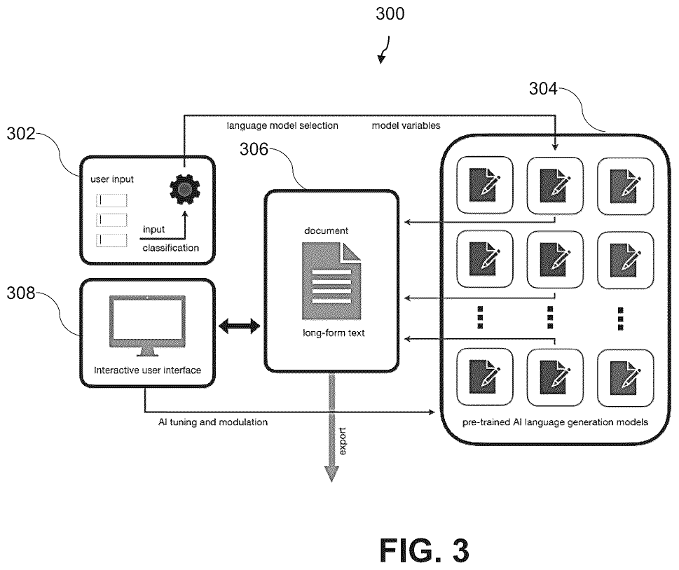

FIG. 3 illustrates an exemplary block diagram representation of a scenario of segment-by-segment modular long-form text generation, in accordance with an embodiment of the present disclosure. The system 102 receives a user input 302, includes a pre-trained artificial intelligence (AI) language generation model 304, a document 306, an interactive user interface 308, and the like. The user input 302 comprises a letter document of recommendations in the form of .docx or .pdf format which is uploaded through a web portal. The user input 302 undergoes classification and further undergoes language model selection which results in outputting model variables and sent to the pre-trained AI language generation model 304. The user input 302 is assigned specific variables that the pre-trained AI language generation model 304 understands through the classification. In the case of the language model selection, a user chooses a particular voice of the pre-trained AI language generation model 304. For example, by enthusiasm, and this choice is translated through to the language model selection. The pre-trained AI language generation model 304 comprises a plurality of modules 106 which are interconnected. The plurality of modules 114 includes an interaction model generation module 206, an artificial specific intelligence (ASI) interface generation module 208, a pattern and issue identification module 210, a machine learning module 212, and an ASI interface optimizer module 214. After analysis of the pre-trained language generation models results in document 306 which is in the form of long-form text and sends the document 306 to an interactive user interface 308 where the document 306 undergoes user review and formatting. The AI-tuned and modulated document is further sent to a pre-trained AI language generation model for subsequent analysis. Next, document 306 after analysis is exported. Document 306 is exported in the .pdf or similar format and document 306 is stored in aggregate on an encrypted cloud server related to a user's account for further retrieval.

### Exemplary Scenarios

For example, consider an artificial specific intelligence (ASI) interface that involves the creation of a specialized AI interface tailored to specific software or workflow systems. The advanced AI may possess a deep understanding of the targeted software or workflow system, comprehending all functionalities and interacting with users in a natural and intuitive manner. It would guide users through tasks, offer assistance, automate complex actions, and even learn to anticipate their needs. To better understand the interaction capabilities enabled by the ASI interface, it is important to distinguish between the two modes. For software interaction, the ASI interface allows human users to achieve high-quality outcomes in situations where they possess technical insight, however, lack domain expertise or time to utilize the software effectively. By accessing application programming interfaces (APIs) of complex third-party software, the ASI interface can replace human input. The ASI interface assists users by providing step-by-step guidance, particularly beneficial for software with steep learning curves or an overwhelming number of parameter combinations. The ASI interface dynamically adapts to user skill levels, offering detailed instructions to beginners and efficient, high-level guidance to experts.

Further, for workflow interaction, the ASI interface also supports users in pre-existing workflow systems, which involve stylized procedures or interactions to obtain desired outcomes. For example, generating a letter of reference for a technical position constitutes a workflow system. The ASI streamlines and automates the workflow, allowing users to obtain the desired results efficiently.

The ASI interface may be built by identifying software and user base by determining the specific software or workflow system targeted by the ASI interface and the user base that will interact with it. This information guides the ASI's design and functionality. Further, for designing the interaction model, the system 102 may define how users may engage with the ASI interface, such as through a chat interface, voice commands, or another medium. The interaction model should capture valuable data on user interactions and challenges faced while using the software. Further, to develop the ASI framework, the designer may create an initial version of the ASI interface, incorporating the defined interaction model. This version may have limited functionality but should be capable of interacting with users and collecting data.

Additionally, deploying and monitoring the ASI interface involves deploying it to a subset of the user base and closely monitor their interactions. This process aims to gather information on how users engage with the ASI, the questions they ask, and the issues they encounter. The system 102 analyzes the collected data to identify patterns and pre-defined challenges. This analysis may reveal tasks that users struggle with or questions the ASI currently cannot effectively address. Furthermore, the system 102 utilizes insights from the data analysis to enhance the ASI interface. This may involve training new machine learning models to better understand user questions or automate specific tasks. Interface modifications may also be made to improve intuitiveness. The system 102 may continuously learn for the ASI interface to continuously learn from ongoing user interactions. This could involve techniques like online machine learning, updating the model with new data, or active learning, where the ASI identifies areas of uncertainty and requests additional training data from users. Also, the system 102 receives user feedback from users to gain insights beyond the interaction data. User feedback provides valuable information on their overall experience with the ASI.

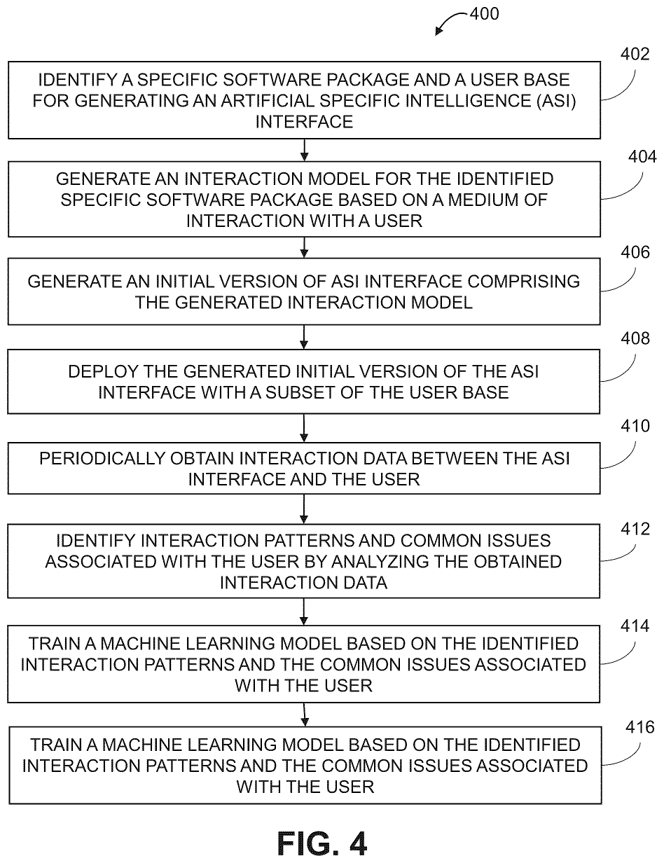

FIG. 4 illustrates a flow chart depicting a method 400 of developing an artificial specific intelligence (ASI) interface for specific software, in accordance with the embodiment of the present disclosure.

At block 402, the method 400 may include identifying, by one or more hardware processors 110, a specific software package and a user base for generating an artificial specific intelligence (ASI) interface.

At block 404, the method 400 may include generating, by the one or more hardware processors 110, an interaction model for the identified specific software package based on a medium of interaction with a user.

At block 406, the method 400 may include generating, by the one or more hardware processors 110, an initial version of the ASI interface comprising the generated interaction model.

At block 408, the method 400 may include deploying, by the one or more hardware processors 110, the generated initial version of the ASI interface with a subset of the user base.

At block 410, the method 400 may include periodically obtaining, by the one or more hardware processors 110, interaction data between the ASI interface and the user.

At block 412, the method 400 may include identifying, by the one or more hardware processors 110, interaction patterns and pre-defined issues associated with the user by analyzing the obtained interaction data.

At block 414, the method 400 may include training, by the one or more hardware processors 110, a machine-learning model based on the identified interaction patterns and the pre-defined issues associated with the user.

At block 416, the method 400 may include optimizing, by the one or more hardware processors 110, the initial version of the ASI interface based on the trained machine learning model.

The method 400 may be implemented in any suitable hardware, software, firmware, or combination thereof. The order in which the method 400 is described is not intended to be construed as a limitation, and any number of the described method blocks may be combined or otherwise performed in any order to implement the method 400 or an alternate method. Additionally, individual blocks may be deleted from the method 400 without departing from the spirit and scope of the present disclosure described herein. Furthermore, the method 400 may be implemented in any suitable hardware, software, firmware, or a combination thereof, that exists in the related art or that is later developed. The method 400 describes, without limitation, the implementation of the system 102. A person of skill in the art will understand that method 400 may be modified appropriately for implementation in various manners without departing from the scope and spirit of the disclosure.

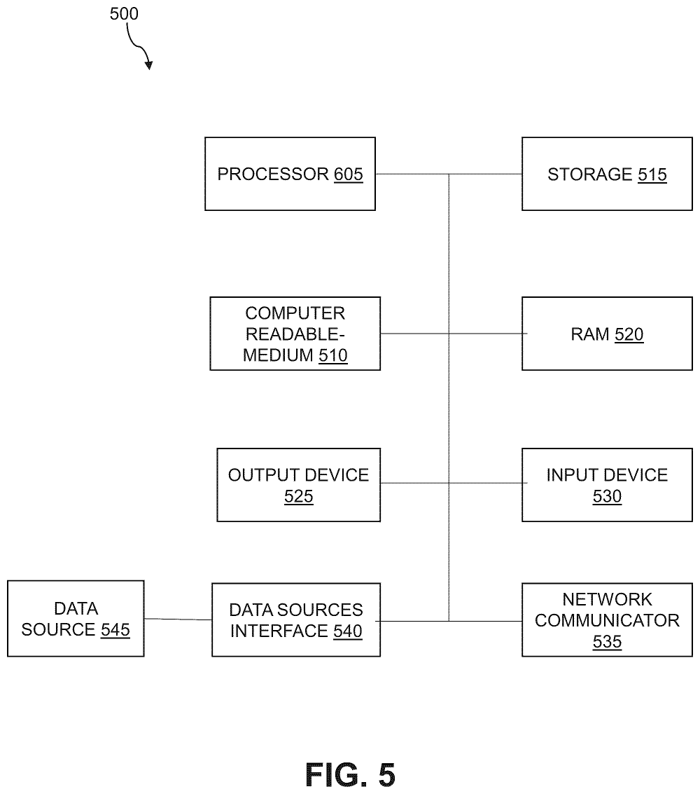

FIG. 5 illustrates an exemplary block diagram representation of a hardware platform 500 for implementation of the disclosed system 102, according to an example embodiment of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 500. As illustrated, the hardware platform 500 may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform 500 may be a computer system such as the system 102 that may be used with the embodiments described herein. The computer system may represent a computational platform that includes components that may be in a server or another computer system. The computer system may be executed by the processor 505 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 505 that executes software instructions or code stored on a non-transitory computer-readable storage medium 510 to perform methods of the present disclosure. The software code includes, for example, instructions to gather data and analyze the data. For example, the plurality of modules 114 includes an interaction model generation module 206, an artificial specific intelligence (ASI) interface generation module 208, a pattern and issue identification module 210, a machine learning module 212, and an ASI interface optimizer module 214.

The instructions on the computer-readable storage medium 510 are read and stored the instructions in storage 515 or random-access memory (RAM). The storage 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interacting with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for example. A network communicator 535 may include, for example, a network adapter such as a LAN adapter or a wireless adapter. The computer system may include a data sources interface 540 to access the data source 545. The data source 545 may be an information resource. As an example, a database of exceptions and rules may be provided as the data source 545. Moreover, knowledge repositories and curated data may be other examples of the data source 545.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

What is claimed is:

1. A computing system for developing an artificial specific intelligence (ASI) interface for a specific software, the computing system comprising:
one or more hardware processors; and
a memory coupled to the one or more hardware processors, wherein the memory comprises a plurality of modules in the form of programmable instructions executable by the one or more hardware processors, wherein the plurality of modules comprises:
an interaction model generation module configured to:
identify a specific software package and a user base for generating an artificial specific intelligence (ASI) interface; and
generate an interaction model for the identified specific software package based on a medium of interaction with a user;
an artificial specific intelligence (ASI) interface generation module configured to:
generate an initial version of the ASI interface comprising the generated interaction model; and
deploy the generated initial version of the ASI interface with a subset of the user base;
a pattern and issue identification module configured to:
periodically obtain interaction data between the ASI interface and the user; and
identify interaction patterns and pre-defined issues associated with the user by analyzing the obtained interaction data;
a machine learning module configured to:
train a machine learning model based on the identified interaction patterns and the pre-defined issues associated with the user; and
an ASI interface optimizer module configured to:
optimize the initial version of the ASI interface based on the trained machine learning model.

2. The computing system of claim 1, wherein the ASI interface optimizer module is further configured to:
generate one or more machine learning-based insights for the identified interaction patterns and pre-defined issues associated with the user.

3. The computing system of claim 1, wherein to identify the interaction patterns and the pre-defined issues associated with the user by analyzing the obtained interaction data, the pattern and issue identification module is configured to:
identify user behavior patterns and user preference patterns on the ASI interface; and
store the identified user behavior pattern and the user preference pattern in the ASI interface.

4. The computing system of claim 1, wherein to optimize the initial version of the ASI interface based on the trained machine learning model, the ASI interface optimizer module is configured to:
learn one or more types of tasks performed by the user on the ASI interface;
generate accessible instances of the one or more types of tasks performed by the user; and
provide the generated accessible instances of the one or more types of tasks to the user at run-time.

5. The computing system of claim 1, wherein to optimize the initial version of the ASI interface based on the trained machine learning model, the ASI interface optimizer module is configured to:
analyze the identified specific software package received as input from the user;
execute one or more test assessments on the specific software package via an application programming interface; and
optimize the initial version of the ASI interface based on the results of the one or more test assessments.

6. The computing system of claim 1, wherein to optimize the initial version of the ASI interface based on the trained machine learning model, the ASI interface optimizer module is configured to:
automate complex sequences of actions required to be performed on the specific software package based on the identified interaction patterns and the pre-defined issues associated with the user.

7. The computing system of claim 1, wherein to optimize the initial version of the ASI interface based on the trained machine learning model, the ASI interface optimizer module is configured to:
interpret user input commands received from the user with a disability; and
generate one or more user-preferred output commands corresponding to the ASI interface based on the interpreted user input commands received from the user with the disability, wherein the one or more user-preferred output commands correspond to a type of disability of the user.

8. The computing system of claim 1, wherein to train the machine learning model based on the identified interaction patterns and the pre-defined issues associated with the user, the machine learning module is configured to:
receive unstructured text data as the user base from the user;
classify and select language models for the received unstructured text data based on the user base to generate model variables;
assign the generated model variables to the identified interaction patterns to generate desired text data;
analyze the interaction patterns of the user with the ASI interface using a pre-trained language generation model to generate the desired text data;
display the desired text data on the ASI interface for reviewing and formatting;
tune and modify the desired text data based on the user preference and the identified pre-defined issues associated with the user; and
retrain the machine learning model based on the tuned and modified desired text data.

9. The computing system of claim 8, wherein the machine learning module is further configured to:
pre-process the unstructured text data obtained from letters of reference extracted from the user base;
generate machine-learning-based summaries of the pre-processed unstructured text data using an AI-based summarization algorithm;
validate the generated machine-learning-based summaries based on one or more predefined rules; and
map text with the model variables to generate a long-form structured text data desired by the user.

10. The computing system of claim 9, wherein to pre-process the unstructured text data obtained from letters of reference extracted from the user base, the machine learning module is further configured to:
parse of letters comprised in the unstructured text data using a decision tree-based model to filter segments lacking actionable intent;
filter unstructured text data to remove gendered language; and
tune of stereotyped phrases to generate a neutral tone in the unstructured text data.

11. The computing system of claim 9, wherein to generate the machine-learning-based summaries of the pre-processed unstructured text data using the AI-based summarization algorithm, the machine learning module is further configured to:
generate the machine-learning-based summaries of the pre-processed unstructured text data using a transformer encoder-encoder machine learning model with a bidirectional encoder and an autoregressive decoder.

12. A computer-implemented method for developing an artificial specific intelligence (ASI) interface for specific software, the computer-implemented method comprising:
identifying, by one or more hardware processors, a specific software package and a user base for generating an artificial specific intelligence (ASI) interface;
generating, by the one or more hardware processors, an interaction model for the identified specific software package based on a medium of interaction with a user;
generating, by the one or more hardware processors, an initial version of the ASI interface comprising the generated interaction model;
deploying, by the one or more hardware processors, the generated initial version of the ASI interface with a subset of the user base;
periodically obtaining, by the one or more hardware processors, interaction data between the ASI interface and the user;
identifying, by the one or more hardware processors, interaction patterns and pre-defined issues associated with the user by analyzing the obtained interaction data;
training, by the one or more hardware processors, a machine learning model based on the identified interaction patterns and the pre-defined issues associated with the user; and
optimizing, by the one or more hardware processors, the initial version of the ASI interface based on the trained machine learning model.

13. The computer-implemented method of claim 12 further comprising:
generating, by the one or more hardware processors, one or more machine learning-based insights for the identified interaction patterns and pre-defined issues associated with the user.

14. The computer-implemented method of claim 12, wherein identifying the interaction patterns and the pre-defined issues associated with the user by analyzing the obtained interaction data, further comprises:
identifying, by the one or more hardware processors, user behavior patterns and user preference patterns on the ASI interface; and
storing, by the one or more hardware processors, the identified user behavior pattern and the user preference pattern in the ASI interface.

15. The computer-implemented method of claim 12, wherein optimizing the initial version of the ASI interface based on the trained machine learning model, further comprises:
learning, by the one or more hardware processors, one or more types of tasks performed by the user on the ASI interface;
generating, by the one or more hardware processors, accessible instances of the one or more types of tasks performed by the user; and
providing, by the one or more hardware processors, the generated accessible instances of the one or more types of tasks to the user at run-time.

16. The computer-implemented method of claim 12, wherein optimizing the initial version of the ASI interface based on the trained machine learning model, further comprises:
analyzing, by the one or more hardware processors, the identified specific software package received as input from the user;
executing, by the one or more hardware processors, one or more test assessments on the specific software package via an application programming interface;
optimizing, by the one or more hardware processors, the initial version of the ASI interface based on the results of the one or more test assessments;
automating, by the one or more hardware processors, complex sequences of actions required to be performed on the specific software package based on the identified interaction patterns and the pre-defined issues associated with the user;
interpreting, by the one or more hardware processors, user input commands received from the user with a disability; and
generating, by the one or more hardware processors, one or more user-preferred output commands corresponding to the ASI interface based on the interpreted user input commands received from the user with the disability, wherein the one or more user-preferred output commands correspond to a type of disability of the user.

17. The computer-implemented method of claim 12, wherein training the machine learning model based on the identified interaction patterns and the pre-defined issues associated with the user, further comprises:
receiving, by the one or more hardware processors, unstructured text data as the user base from the user;
classifying and selecting, by the one or more hardware processors, language models for the received unstructured text data based on the user base to generate model variables;
assigning, by the one or more hardware processors, the generated model variables to the identified interaction patterns to generate desired text data;
analyzing, by the one or more hardware processors, the interaction patterns of the user with the ASI interface using a pre-trained language generation model to generate the desired text data;
displaying, by the one or more hardware processors, the desired text data on the ASI interface for reviewing and formatting;
tuning and modifying, by the one or more hardware processors, the desired text data based on the user preference and the identified pre-defined issues associated with the user; and
retraining, by the one or more hardware processors, the machine learning model based on the tuned and modified desired text data.

18. The computer-implemented method of claim 19 further comprising:
pre-processing, by the one or more hardware processors, the unstructured text data obtained from letters of reference extracted from the user base;
generating, by the one or more hardware processors, machine-learning-based summaries of the pre-processed unstructured text data using at least one of an AI-based summarization algorithm, a transformer encoder-encoder machine learning model with a bidirectional encoder and an autoregressive decoder;
validating, by the one or more hardware processors, the generated machine-learning-based summaries based on one or more predefined rules; and
mapping, by the one or more hardware processors, text with the model variables to generate a long form structured text data desired by the user.

19. The computing system of claim 9, wherein pre-processing the unstructured text data obtained from letters of reference extracted from the user base, the machine learning module is further configured to:
parse of letters comprised in the unstructured text data using a decision tree-based model to filter segments lacking actionable intent;
filter unstructured text data to remove gendered language; and
tune of stereotyped phrases to generate a neutral tone in the unstructured text data.

20. A non-transitory computer-readable storage medium having programmable instructions stored therein, that when executed by one or more hardware processors, cause the one or more hardware processors to:
identify a specific software package and a user base for generating an artificial specific intelligence (ASI) interface;
generate an interaction model for the identified specific software package based on a medium of interaction with a user;
generate an initial version of the ASI interface comprising the generated interaction model;
deploy the generated initial version of the ASI interface with a subset of the user base;
periodically obtain interaction data between the ASI interface and the user;
identify interaction patterns and pre-defined issues associated with the user by analyzing the obtained interaction data;
train a machine learning model based on the identified interaction patterns and the pre-defined issues associated with the user, and
optimize the initial version of the ASI interface based on the trained machine learning model.
